(19) United States
(12) Patent Application Publication
(10) Pub. No.: US 2008/0257926 A1
(43) Pub. Date: Oct. 23, 2008

(54) Carrying Apparatus for Use with a Cycle

(76) Inventors: Meng-Kuei Chou, Fengshan City (TW); Jung-Hui Weng, Kaohsiung City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/100,468

(22) Filed: Apr. 10, 2008

(30) Foreign Application Priority Data
Apr. 19, 2007 (TW) 096206257

(51) Int. Cl. B62J 9/00

(52) U.S. Cl. 224/427

(57) ABSTRACT

A carrying apparatus for use with cycle comprises a box, a bag and a seat. Said box has a first case, a second case, and two connectors. The first case has a side-wall providing an opening, and two end-walls connecting to two opposite edges of the side-wall and being two opposite sides of the box; the second case is movably received in the first case to reveal or conceal the opening thereof; and the two connectors pivotably couple to the two end-walls respectively. Said bag has at least one window, with a pair of join members being arranged and adjacent to two opposite edges of the bag for adhering to or engaging with each other and one of the two opposite edges being linked to the box. Said seat connects with the two connectors of the box for coupling the box to a cycle.

### BACKGROUND OF THE INVENTION

1. Field of the Invention

The present invention relates to a carrying apparatus for use with cycle, and specifically, to a carrying apparatus comprising a first case, a second case received within the first case to jointly form a box, and a bag having at least one window and winding around said box.

2. Description of the Related Art

A conventional carrying apparatus for use with cycle is disclosed in a Taiwan patent numbered 299744 and named “carrying box for use with bicycle”. The proposed carrying box comprises a first case, a second case and a lid, with the first and second cases jointly forming a container, three holes for being combined with a bicycle, and an opening for goods to be put into the container. The lid is pivotably coupled with an edge of the opening for revealing or sealing the opening, and goods received inside the container may thus safely stay therein when the bicycle is moving.

Through the above-mentioned structure of the carrying box, steps for mounting said carrying box are executed as the following. From two opposite sides of the bicycle, the first and second cases abut on each other and jointly form the container, with a head tube and a down tube of the bicycle passing through said three holes and being partially received in the container. Furthermore, the lid is pivotably fastened between said first and second cases, such that the opening is revealed or concealed while the lid is raised or lowered. Finally, a plurality of screws is applied for firmly assembling the container and fixing the container at a position around a connect section of the head tube and down tube. Moreover, there are two sealing washers around two of the holes through which is the head tube, with the sealing washers being tightly fastened between the two cases and the head tube so as to prevent water from flowing into the container along the head tube.

Nevertheless, such a carrying box still has some drawbacks in practical applications. For example, because the container is fixed around the connect section of the head tube and down tube while the opening is disposed at the top of the container, said carrying box is unsuitable for use with a bicycle having a crossbar which may hinder the lid from being raised freely. Besides, diameters of the head tube and down tubes and the angles between said two tubes may be different by various bicycles, which will also limit scopes in use of the conventional carrying box. Furthermore, owing to the position where the carrying box disposed, it is impossible for the carrying box to provide a user with a map-showing function when the user is riding the bicycle. Hence, there is a need for improving the conventional carrying box.

### SUMMARY OF THE INVENTION

The primary objective of this invention is to provide a carrying apparatus for use with cycle. The carrying apparatus comprises a box and a bag, with the bag being able to wind around said box and providing a window facing outwardly. Consequently, the proposed carrying apparatus is convenient for a user to place goods and look at a map while the user is riding the cycle.

The secondary objective of this invention is to provide a carrying apparatus for use with cycle with a box being pivotably coupled with a seat and the seat mounting with a handle bar of a cycle. Consequently, the proposed carrying apparatus can be applied to every kind of cycle.

A carrying apparatus for use with cycle in accordance with an aspect of the present invention comprises a box, a bag and a seat. Said box has a first case, a second case, and two connectors. The first case has a side-wall providing an opening, and two end-walls connecting to two opposite edges of the side-wall and being two opposite sides of the box; the second case is movably received in the first case to reveal or conceal the opening thereof; and the two connectors pivotably couple to the two end-walls respectively. Said bag has at least one window, with a pair of join members being arranged and adjacent to two opposite edges of the bag for adhering to or engaging with each other and one of the two opposite edges being linked to the box. Said seat connects with the two connectors of the box for coupling the box to a cycle.

In a separate aspect of the present invention, each of the two end-walls further comprises a pivotal protrusion, and each of the two connectors has a passage to pivotably receive the pivotal protrusion.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is an exploded perspective view illustrating a carrying apparatus for use with cycle in accordance with a preferred embodiment of the present invention;

FIG. 2 is a cross-sectional top view illustrating the carrying apparatus for use with cycle in accordance with the preferred embodiment of the present invention;

FIG. 3 is a cross-sectional side view illustrating the carrying apparatus for use with cycle in accordance with the preferred embodiment of the present invention;

FIG. 4 is a detailed and cross-sectional side view illustrating the carrying apparatus for use with cycle in accordance with the preferred embodiment of the present invention;

FIG. 5 is a cross-sectional side view illustrating the carrying apparatus for use with cycle in use in accordance with the preferred embodiment of the present invention;

FIG. 6 is a perspective view illustrating the carrying apparatus for use with cycle when the carrying apparatus is coupled with a bicycle in accordance with the preferred embodiment of the present invention; and

FIG. 7 is a perspective view illustrating the carrying apparatus for use with cycle when the carrying apparatus is coupled with a belt member in accordance with the preferred embodiment of the present invention.

### DETAILED DESCRIPTION OF THE INVENTION

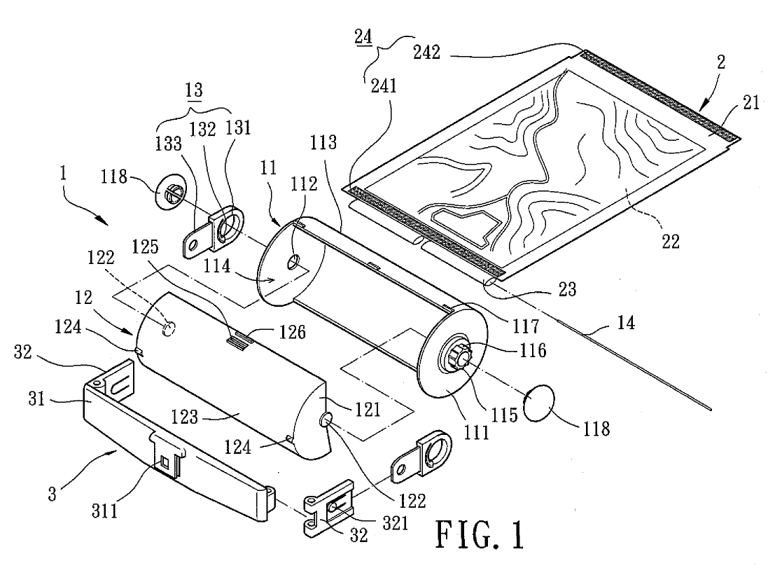

Referring to FIG. 1, an exploded perspective view of a carrying apparatus for use with cycle in accordance with a preferred embodiment of the present invention is illustrated. The carrying apparatus comprises a box 1 in a tube shape, a bag 2 winding around the circumference of the box 1, and a seat 3 coupling the box 1 and bag 2 to a cycle like a bicycle. Moreover, said tube shape is preferable a cylinder; however, other tube shape with a polygonal cross-section such as a hexagonal prism being able to receive goods can also be used.

The box 1 of the present invention comprises a first case 11, a second case 12, two connectors 13 and a linking rod 14, and the details of these components are illustrated as the following.

Please refer to FIG. 1 again, the first case 11 comprises two end-walls 111, two through holes 112, a side-wall 113, an opening 114, two pivotal protrusions 115, a plurality of grooves 116 and a plurality of holders 117. Said two end-walls 111 are two opposite ends of the first case 11, with each of the end-walls 111 having one of the two through holes 112 that align with each other and preferably are arranged at centers of the end-walls 111 respectively. The side-wall 113 is between the two end-walls 111, which respectively connects with rims of said two end-walls 111; thereby, an inner space within the first case 11 is defined by the two end-walls 111 and side-wall 113. The opening 114 is disposed at the side-wall 113 and also preferably extends from one of the end-walls 111 to the other. The two pivotal protrusions 115 are respectively formed on surfaces of the two end-walls 111, with the pivotal protrusions 115 protruding outwardly and being formed around the through holes 112. The grooves 116 are disposed on circumferences of the two pivotal protrusions 115, and for each pivotal protrusion 115, directions in which the grooves 116 extending are preferably parallel to a longitudinal direction of the first case 11. The holders 117 are arranged on a surface of the side-wall 113, which faces outwardly, and are preferably lined in a direction parallel to the longitudinal direction of the first case 11 for firmly holding the linking rod 14.

The second case 12 comprises two end-walls 121, two pivotal pins 122, a side-wall 123, two limiting blocks 124, a pressed section 125 and an engaging member 126 and is received by the first case 11 in the inner space and is taken as a cover of the opening 114. The two side-walls 121 are two opposite ends of the second case 12 and adjacent to the end-walls 111 of the first case 11. The two pivotal pins 122 are respectively disposed on the end-walls 121 and enter the through holes 112 of the first case 11, so as to be taken as pivots for the second case 12 to revolve around the through holes 112. The side-wall 123 respectively connects with rims of said two end-walls 121, and the inner space is thus partially laid between the two end-walls 121 and side-wall 123. The two limiting blocks 124, which face outwardly through the opening 114 of the first case 11, are formed on a surface of the side-wall 123, with a distance between said surface and a top of each limiting block 124 being larger than that between the two side-walls 113, 123. And the two limiting blocks 124 are preferably adjacent to the end-walls 121 respectively. The pressed section 125 is also arranged on the same surface where the limiting blocks 124 are formed and is exposed through the opening 114, wherein the pressed section 125 is preferably selected from grooves, ribs or the like. The engaging member 126 protrudes from the same surface where the limiting blocks 124 and pressed section 125 are formed and is adjacent to a free edge of the side-wall 123. Moreover, the pressed section 125 and the engaging member 126 are on the same side of a link line of the limiting blocks 124.

Each of the two connectors 13 has a passage 131, an elastic hook 132 and a connecting member 133. The passage 131 loosely and pivotably receives one of the two pivotal protrusions 115 of the first case 1. The elastic hook 132 inwardly protrudes from a surface of the passage 131 to engage with the grooves 116 of the first case 11, and at least either edge of the elastic hook 132 or that of each groove 116 is smooth and arc-shaped. The connecting member 133 forms a side of the connector 13 and is for connecting the connector 13 with the seat 3. Through the above components of each connector 13, the box 1 is coupled with the seat 3 and able to be turned.

The linking rod 14 extends through a side of the bag 2 and is held by the holders 117 of the first case 11, so that the box 1 and bag 2 are linked up.

Please still refer to FIG. 1, the bag 2 of the present invention is flat-shaped, so as to receive at least one sheet of paper such as a map and perfectly wind around the circumference of the box 1. Said bag 2 comprises a first surface 21, a second surface 22, at least one ring 23, and a pair of join members 24. The first surface 21 has a window for a user to look at the at least one sheet of paper received in the bag 2. The second surface 22 is oppositely arranged against to the first surface 21, and there may also be a window provided at the second surface 22. The at least one ring 23 forms an edge of the bag 2 for the linking rod 14 to pass through, so as to link up the box 1 and bag 2. The pair of join members 24 is arranged and close to two opposite edges of the bag 2, with a first join member 241 of the join members 24 being adjacent to the edge where the at least one ring 23 is disposed and a second join member 242 of the join members 24 being adjacent to an opposite edge. Said first and second join members 241, 242 can adhere to or engage with each other, and the first join member 241 forms on the first surface 21 of the bag 2 while the second join member 242 forms on the second surface 22 thereof.

Please still refer to FIG. 1, the seat 3 of the present invention comprises a body 31 and two connecting arms 32. The body 31 provides a connecting section 311 to be mounted on a cycle. The two connecting arms 32 respectively extend from two ends of the body 31, with each of the connecting arms 32 having an elastic knob 321 to firmly engage with the corresponding connecting member 133 of the connector 13. Furthermore, both of the connecting arms 32 can preferably be rotated relatively to the body 31 and covered onto a surface of the body 31.

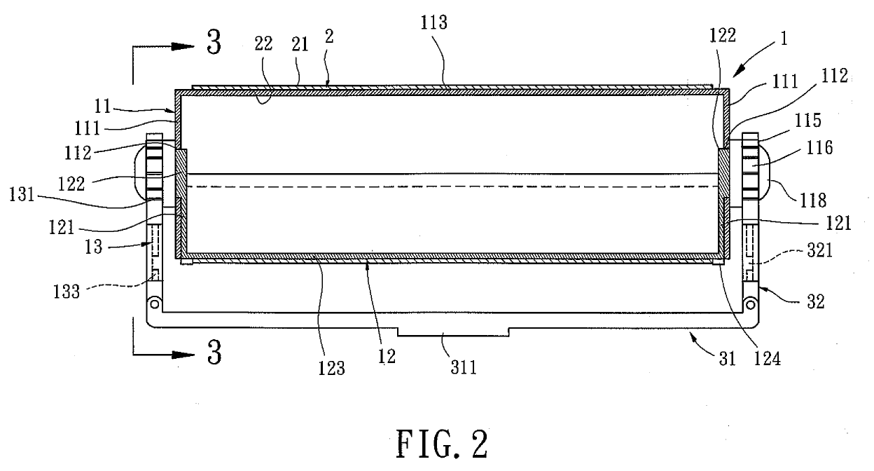

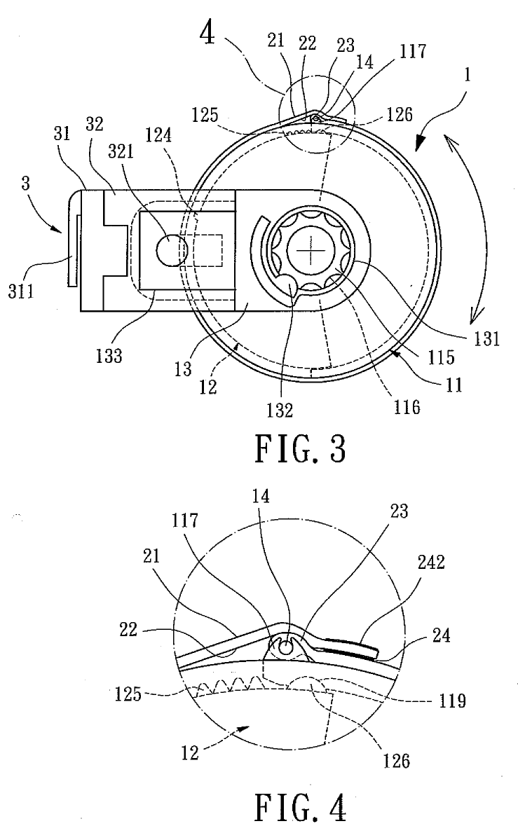

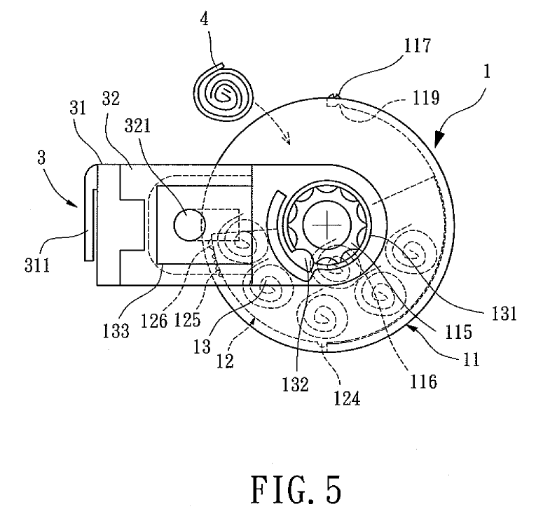

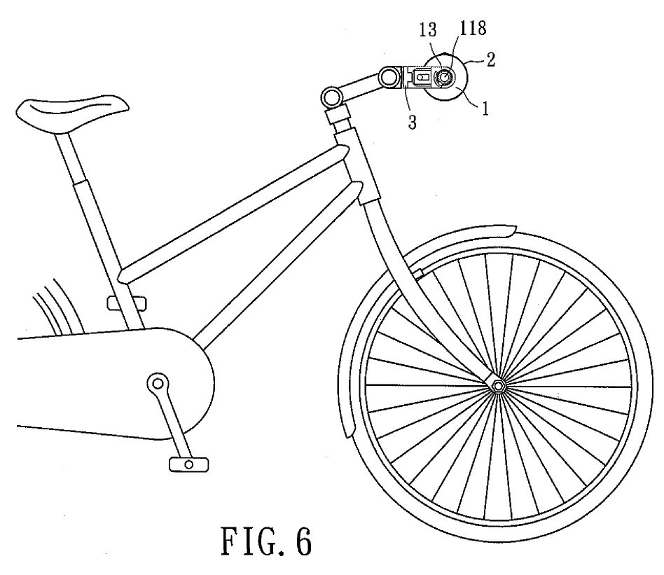

Further referring to FIGS. 1 through 4 now, the carrying apparatus of the present invention is assembled by the following steps. By passing through the opening 114, the second case 12 is received in the first case 11 with the two pivotal pins 122 being respectively and movably coupled to the through holes 112 of the first case 11. The second case 12 is thereby able to revolve within the first case 11 to reveal or conceal the opening 114. Each of the two pivotal protrusions 115 of the first case 11 passes through the passage 131 of one of the connectors 13, and the elastic hook 132 enters one of the grooves 116 of the first case 11 and abuts against a surface of the groove 116. Therefore, through said elastic hook 132 and entered groove 116, the first case 11 is prevented from freely revolving relatively to the connectors 13. Moreover, a positioning cap 118 can be put on a free end of each pivotal protrusion 115, with a round edge of the positioning cap 118 passing through one of the through holes 112 and engaging with the pivotal protrusion 115 adjacent to the passed through hole 112. A head of the positioning cap 118 has a diameter larger than that of the passage 131 of the connector 13 to prevent the pivotal protrusion 115 of the first case 11 from leaving the passage 131 of the connector 13. The linking rod 14 extends through the at least one ring 23 of the bag 2 and is held by the holders 117 in the meanwhile, so as to link the first case 11 and bag 2. Each of the elastic knobs 321 of the connecting arms 32 engages with one of the connecting members 133 of the connectors 13, such that the box 1 and seat 3 are firmly combined with each other.

In use, the bag 2 can wind around the box 1 and be positioned through the join members 24 with the first surface 21 facing outwardly to show the window for a user to look into the bag 2. For the same reason, there can be another window arranged at the second surface 22 and another pair of join members 24 with a first join member 241 thereof forming on the second surface 22 and a second join member 242 thereof forming on the first surface 21.

Besides, the first case 11 can revolve relatively to the connectors 13 while an external force applied to the first case 11 is larger than a predetermined value. In detail, when the external force is lower than the predetermined value, that is, not enough to force the elastic hook 132 backing off and being out of the entered groove 116, the box 1 is maintained in the same position. On the contrary, the elastic hook 132 will back of, exit from the entered groove 116, and enter an adjacent one if the external force is greater than the predetermined value. Said predetermined value can be adjusted through changing curves of the edges of said elastic hook 132 and grooves 116.

When the second case 12 conceals the opening 114, the engaging member 126 abuts against an inner surface of the side-wall 113, which faces to the inner space, so as to engage with the side-wall 113 and keep concealment of the opening 114. Corresponding to the engaging member 126, an engaging cavity 119 is selectively disposed at said inner surface of the side-wall 113 for the engaging member 126 to enter and engage with. When the second case 12 reveals the opening 114, the limiting block 124 restricts a movement of the second case 12 to provide a restricted movable range. Thus, goods can be put into the inner space through the opening 114 when it is revealed and be safely kept in said inner space when the opening 114 is concealed. Furthermore, through pressing the pressed section 125 and sliding the second case 12 relatively to the first case 11, a user can easily achieve a purpose to open or close the box 1.

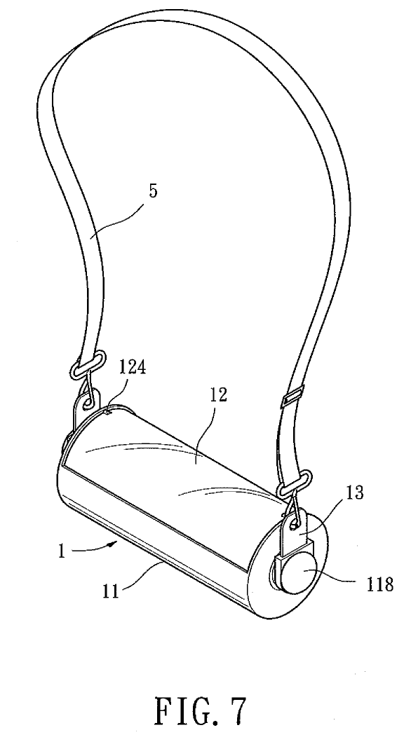

Turning now to FIGS. 6 and 7, the seat 3 of the present invention can mount the box 1 onto the cycle. Moreover, whether the cycle is a bicycle or a motorcycle, the seat 3 is mounted on a stem or a handlebar. Therefore, a user can easily open or close the box 1 and look at a map, namely the at least one sheet of paper, received in the bag 2 through the window. And while the second surface 22 also provides a said window, it is convenient to look a reverse side of the map, with the bag 2 reversely winding around the box 1 and showing said reverse side of the map through the window. When the connecting members 133 of the connectors 13 disengaged with the elastic knobs 321 of the connecting arms 32, the box 1 is thus separated from the seat 3 and can be engaged with a belt member 5 connecting between the two connecting members 133 for a user to shoulder.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. A carrying apparatus for use with cycle, comprising:
a box having an opening, two end-walls being two opposite sides of the box, and two connectors pivotably coupling to the two end-walls respectively;
a bag having at least one window, with a pair of join members being arranged and adjacent to two opposite edges of the bag for adhering to or engaging with each other and one of the two opposite edges being linked to the box;
a seat connecting with the two connectors of the box for coupling the box to a cycle.

2. The carrying apparatus for use with cycle as defined in claim 1, wherein the box further comprises a cover to conceal the opening.

3. The carrying apparatus for use with cycle as defined in claim 1, wherein each of the two end-walls further comprises a pivotal protrusion, and each of the two connectors has a passage to pivotably receive the pivotal protrusion.

4. The carrying apparatus for use with cycle as defined in claim 3, wherein a circumference of each pivotal protrusion has a plurality of grooves extending in directions parallel to a longitudinal direction of the box, and a elastic hook inwardly protrudes from a surface of the passage to engage with one of the grooves.

5. The carrying apparatus for use with cycle as defined in claim 1, wherein the two connectors are able to be separated from the seat and connect to two ends of a belt member.

6. A carrying apparatus for use with cycle, comprising:
a box having a first case, a second case, and two connectors, with the first case having a side-wall providing an opening, and two end-walls connecting to two opposite edges of the side-wall and being two opposite sides of the box, with the second case being movably received in the first case to reveal or conceal the opening thereof, with the two connectors pivotably coupling to the two end-walls respectively;
a bag having at least one window, with a pair of join members being arranged and adjacent to two opposite edges of the bag for adhering to or engaging with each other and one of the two opposite edges being linked to the box;
a seat connecting with the two connectors of the box for coupling the box to a cycle.

7. The carrying apparatus for use with cycle as defined in claim 6, wherein each of the two end-walls further comprises a pivotal protrusion, and each of the two connectors has a passage to pivotably receive the pivotal protrusion.

8. The carrying apparatus for use with cycle as defined in claim 7, wherein a circumference of each pivotal protrusion has a plurality of grooves extending in directions parallel to a longitudinal direction of the box, and a elastic hook inwardly protrudes from a surface of the passage to engage with one of the grooves.

9. The carrying apparatus for use with cycle as defined in claim 6, wherein at least one limiting block is formed on a surface of a side-wall of the second case and faces outwardly through the opening to provide a restricted movable range of the second case relative to the first case.

10. The carrying apparatus for use with cycle as defined in claim 6, wherein a pressed section is arranged on a surface of the second case and faces outwardly.

11. The carrying apparatus for use with cycle as defined in claim 6, wherein an engaging member protrudes from a surface of a side-wall of the second case and faces outwardly for abutting against an inner surface of the side-wall of the first case to keep concealment of the opening.

12. The carrying apparatus for use with cycle as defined in claim 6, wherein an engaging member protrudes from a surface of a side-wall of the second case and faces outwardly, and an engaging cavity is disposed at an inner surface of the side-wall of the first case correspondingly to the engaging member, with the engaging member and cavity being able to engage with each other to keep concealment of the opening.

13. The carrying apparatus for use with cycle as defined in claim 6, wherein the two connectors are able to be separated from the seat and connect to two ends of a belt member.
